(19) United States
(12) Patent Application Publication
(10) Pub. No.: US 2022/0363221 A1
(43) Pub. Date: Nov. 17, 2022

(54) ANTI-THEFT SYSTEM FOR VEHICLES

(71) Applicant: Eng Heng, San Jose, CA (US)

(72) Inventor: Eng Heng, San Jose, CA (US)

(21) Appl. No.: 17/717,979

(22) Filed: Apr. 11, 2022

Related U.S. Application Data
(60) Provisional application No. 63/187,810, filed on May 12, 2021.

(51) Int. Cl. B60R 25/34; B60R 25/10; B60R 25/104; B60R 25/102

(52) U.S. Cl. CPC B60R 25/34; B60R 25/1001; B60R 25/1004; B60R 25/104; B60R 25/102; B60R 2025/1013; B60R 2325/205

(57) ABSTRACT

An anti-theft system for a vehicle parked and engine off, wherein the antitheft system can detect a forceful opening of a toolbox in the vehicle. The anti-theft system can include a vibration sensor coupled to the body of the vehicle and configured to detect vibration in the body due to an external impact, such as the forceful opening of the toolbox. The control unit coupled to the vibration sensor can receive a signal from the vibration sensor indicative of the external impact and in turn, can raise an alarm notifying the external impact.

### CROSS-REFERENCE TO RELATED APPLICATIONS

This application claims priority to the U.S. provisional patent application Ser. No. 63/187,810, filed on May 12, 2021, which is incorporated herein by reference in its entirety.

### FIELD OF INVENTION

The present invention relates to an anti-theft system for vehicles, and more particularly, the present invention relates to a vibration-sensor-based anti-theft system for vehicles.

### BACKGROUND

Thefts from vehicles have been an unsolved and serious problem for vehicle owners. A vehicle can have costly tools which if stolen results in huge economic loss to the owner and the trouble to procure new ones. For example, often trade tools get stolen from a locked toolbox installed in the rear of trucks. Incidents of such theft are more in the areas wherein vehicles are parked in the streets.

Thus, a desire is there for an anti-theft system that can trigger an alarm to notify a theft attempt from a vehicle.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an anti-theft system for vehicles for preventing the theft of tools.

It is another object of the present invention that the anti-theft system is economical to manufacture.

It is still another object of the present invention that the anti-theft system can be retrofitted in a vehicle.

It is yet another object of the present invention that the anti-theft system can notify nearby people with an alarm about the attempt to steal the tools from the vehicle.

It is a further object of the present invention that the anti-theft system can notify an owner of the vehicle about the attempt to steal the tools on a smartphone.

In one aspect, disclosed is an anti-theft system for vehicles that are parked and engine turned off. The anti-theft system includes a vibration sensor that can detect any vibrations in the body of the vehicle. The vibration sensor can be operably coupled to a control unit which can receive a signal indicative of the intensity of vibrations from the vibration sensor, and based on a predefined rule, the control unit can trigger an alarm to notify about an attempt to steal from the vehicle.

In one aspect, the anti-theft system can be installed in the vehicle and connected to the vehicle's electrical system.

In one aspect, the alarm can be the vehicle's horn and light, wherein the control unit can trigger either or both the horn and lights of the vehicle to notify the people nearby about the attempt to steal from the vehicle.

In one aspect, the anti-theft system can provide for setting up a threshold for the intensity of vibrations to prevent any false alarm.

In one aspect, the control unit can include a network circuitry for connecting to an external network, wherein the control unit can send a notification to a user device through the network, the notification can be about the attempt to steal from the vehicle.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is an environment diagram of the disclosed anti-theft system, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

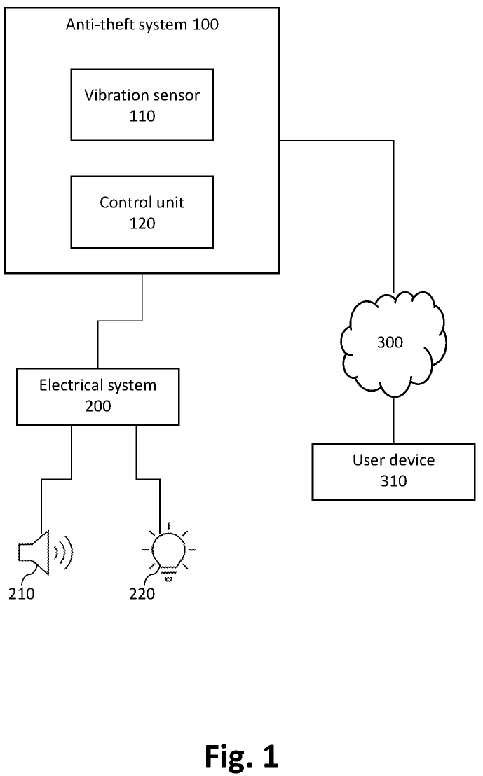

Referring to FIG. 1 which shows the disclosed anti-theft system 100 that can include vibration sensor 110. The vibration sensor 110 can be coupled to the body of the vehicle and can detect vibrations in the body of the vehicle. In one case, the vibrations in the body of the vehicle can be due to an external impact on the body of the vehicle which is parked and engine off. For example, the external impact can be the forceful opening of a toolbox in the vehicle. In trucks, a toolbox can be installed in the rear of the truck and can include tools. Forceful opening of the toolbox can result in vibrations that can be detected by the vibration sensor of the disclosed anti-theft system 100. The vibration sensor can sense vibrations in the wall of a parked vehicle, such as the vibrations caused by the forceful intrusion in the vehicle. The vibration sensors are known in the art. For example, a vibration sensor 110 can be provided that has a precision spring coil, through which a contact pin is installed in the center of the precision spring coil but without contact. Any vibration to this sensor will cause the spring coil to contact the center pin resulting in a signal. Another example of the vibration sensor can be a coil closed at both ends, with a ball bearing inside. Any vibration results in the ball bearing inside the coil reciprocate resulting in a signal. The intensity of the signal can be proportional to the intensity of vibrations detected by the vibration sensor 110.

The anti-theft system 100 can also include a control unit 120 operably coupled to the vibration sensor 110. The control unit 120 can receive a signal from the vibration sensor 110, wherein the signal includes the intensity of the signal. The control unit 120 can also be installed in the vehicle, such as the anti-theft system 100 can be installed in a new vehicle as well as retrofits in an existing vehicle. The anti-theft system 100 can be coupled to an electrical system 200 of a vehicle, such as the anti-theft system 100 can be powered by the electrical system 200 of the vehicle. Alternatively, the anti-theft system 100 can also be powered by a power supply separate from the vehicle's electrical system. Moreover, the anti-theft system 100 can be coupled to the horn 210 and lights 220 of a vehicle. The control unit 120 can trigger either or both the horn 210 and the lights 220 of the parked vehicle in a predetermined pattern as an alarm to gain the attention of the nearby people. for example, the light can be flashed and the horn at short durations, both patterns are indicative of an emergency.

The control unit 120 can receive a signal including the intensity of the signal, which is proportional to the intensity of vibrations picked from the vibration sensor. The control unit 120 can be configured with a threshold for the intensity of vibrations. The control unit 120 can compare if the signal received from the vibration sensor 110 has an intensity of vibration above the predefined threshold. In case, the received intensity of the vibrations is more than the predetermined threshold, the control unit can trigger the horn and/or light as an alarm to notify. The threshold may be such as to avoid any false alarm can be tweaked as and when required.

The control unit 120 can also have a network circuitry that allows the control unit to connect to an external network, such as Wi-Fi or cellular networks. The control unit 120 can also send notifications to a user device 310 through a network 300. The user device 310 can be an electronic device of the owner of the vehicle and can be a smartphone, tablet computer, smartwatch, and smart assistant, and like known consumer electronic devices. Such a step of notification on the user device can be helpful in case the owner is far from the vehicle out of the range of the horn.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An anti-theft system for a vehicle, the anti-theft system comprising:
a vibration sensor configured to couple to a body of the vehicle and detect vibrations in the body of the vehicle due to an external impact on the vehicle, wherein the vehicle is parked and engine off; and
a control unit operably coupled to the vibration sensor, the control unit operably coupled to an electrical system, a horn, and lights of the vehicle,
wherein the control unit is configured to:
receive a signal from the vibration sensor, the signal comprises an intensity of the signal, wherein the intensity of the signal is proportional to an intensity of vibrations detected by the vibration sensor,
comparing the intensity of the signal with a predetermined threshold, and
upon comparing, triggering the horn and/or lights of the vehicle to notify as an alarm about the external impact.

2. The anti-theft system according to claim 1, wherein the control unit further comprises a network circuitry configured for connecting to a network, wherein the control unit is further configured to send a notification on a user device through the network.

3. The anti-theft system according to claim 1, wherein the external impact is a forceful opening of a toolbox installed in a rear of the vehicle.

4. The anti-theft system according to claim 3, wherein the vehicle is a truck.

5. A vehicle comprising a toolbox, the vehicle further comprises:
an anti-theft system for the vehicle, the anti-theft system comprising:
a vibration sensor configured to couple to a body of the vehicle and detect vibrations in the body of the vehicle due to an external impact on the vehicle, wherein the vehicle is parked and engine off; and
a control unit operably coupled to the vibration sensor, the control unit operably coupled to an electrical system, a horn, and lights of the vehicle,
wherein the control unit is configured to:
receive a signal from the vibration sensor, the signal comprises an intensity of the signal, wherein the intensity of the signal is proportional to an intensity of vibrations detected by the vibration sensor,
comparing the intensity of the signal with a predetermined threshold, and
upon comparing, triggering the horn and/or lights of the vehicle to notify as an alarm about the external impact.

6. The vehicle according to claim 5, wherein the control unit further comprises a network circuitry configured for connecting to a network, wherein the control unit is further configured to send a notification on a user device through the network.

7. The vehicle according to claim 5, wherein the external impact is a forceful opening of the toolbox installed in a rear of the vehicle.

8. The vehicle according to claim 7, wherein the vehicle is a truck.

9. The vehicle according to claim 6, wherein the user device is a smartphone.
